(19) United States
(12) Patent Application Publication
(10) Pub. No.: US 2026/0371435 A1
(43) Pub. Date: Nov. 19, 2026

(54) METHOD AND DEVICE FOR SUPPORTING A MULTICAST SERVICE TRANSMISSION

(71) Applicant: Samsung Electronics Co., Ltd., Suwon-si, Gyeonggi-do (KR)

(72) Inventors: Hong WANG, Beijing (CN); Lixiang XU, Beijing (CN); Weiwei WANG, Beijing (CN)

(21) Appl. No.: 19/126,112

(22) PCT Filed: Oct. 31, 2023
(86) PCT No.: PCT/KR2023/017066

§ 371 Date: Apr. 30, 2025

(30) Foreign Application Priority Data
Nov. 2, 2022 (CN) 202211364734.9

(51) Int. Cl. H04W 76/27; H04W 4/06

(52) U.S. Cl. CPC H04W 76/27; H04W 4/06

(57) ABSTRACT

The disclosure relates to a 5G or 6G communication system for supporting a higher data transmission rate. The present invention provides a method and device for supporting a multicast service transmission, herein a method performed by a second node in a wireless communication system is disclosed, the method including: receiving, from a first node, a first message carrying related information of a UE in an RRC inactive state; and processing based on the first message.

### TECHNICAL FIELD

The application relates to wireless communication technology, and specifically, to a method and device for an improved multicast service transmission.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is un-available, and positioning.

Moreover, there has been ongoing standardization in air interface architecture/ protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### DISCLOSURE OF INVENTION

### Technical Problem

In the mobile communication system, service data is provided to users by using broadcast and multicast. This service is called a multimedia broadcast and multicast service, hereinafter referred to as an MBS (Multicast and Broadcast Service). When the MBS is a multicast service, only a UE in an RRC connected mode can receive the data of the MBS service. However, power of the UE is limited, and in order to save power for the UE, the present invention provides a method and device for an improved multicast service transmission.

The present invention has been made to address at least the above problems and/or disadvantages and to provide at least the advantages described below. Accordingly, an aspect of the present invention provides a method and apparatus for supporting a multicast service transmission.

### Solution to Problem

According to an aspect of an embodiment of the present invention, a method performed by a second node in a wireless communication system is provided, the method including: receiving, from a first node, a first message carrying related in-formation of a UE in an RRC inactive state; and processing based on the first message.

According to an embodiment of the present invention, the related information of the UE in the RRC inactive state includes one of: an identifier of the UE; a number of UEs; indication information that there is the UE in the RRC inactive state; a session identifier of an MBS that the UE joins; state information of the MBS; configuration in-formation of an MBS radio bearer (MRB); an area range; indication information of whether to support the UE in the RRC inactive state to receive an MBS service; indication information that MBS context information and/or configuration information continues to be maintained.

According to an embodiment of the present invention, the area range is a RAN paging range or a predetermined list of cells.

According to an embodiment of the present invention, the second node belongs to a same area range as the first node.

According to an embodiment of the present invention, the indication information that there is the UE in the RRC inactive state indicates that there is the UE in the RRC inactive state in a range of the first node or in an area range to which the first node belongs.

According to an embodiment of the present invention, the first message is a UE-specific message.

According to an embodiment of the present invention, the first message is one of:
a message dedicated to MBS multicast; a common message.

According to an embodiment of the present invention, the processing includes at least one of: maintaining, by the second node, UE context information; maintaining, by the second node, MBS context information; continuing, by the second node, a multicast data transmission; not releasing, by the second node, a signaling resource and/or a user plane resource of a multicast service; not initiating a multicast context release request message or not distributing a release command message to the first node by the second node.

According to an embodiment of the present invention, a number of the UE in the RRC inactive state is at least 1.

According to an embodiment of the present invention, the UE in the RRC inactive state is at the first node or an area range to which the first node belongs.

According to an embodiment of the present invention, if the second node is a base station, the processing further includes at least one of: transmitting, to a core network, a request to establish a user plane; transmitting, to a third node, a third message carrying the related information of the UE in the RRC inactive state; transmitting, to the first node, a second message carrying the related information of the UE in the RRC inactive state.

According to an embodiment of the present invention, the third message includes the related information of the UE in the RRC inactive state of the second node and/or related information of the UE in the RRC inactive state of other received nodes.

According to an embodiment of the present invention, a number of the other received nodes is at least 1.

According to an embodiment of the present invention, the second node receives, from the third node, a response message carrying the related information of the UE in the RRC inactive state of the third node.

According to an embodiment of the present invention, MRB configuration in-formation carried in the response message is the same as that carried in the third message.

According to an embodiment of the present invention, the second node is a base station, a distributed unit (DU) or a central unit (CU), and the first node is a base station or a central unit (CU).

According to another aspect of an embodiment of the present invention, a method performed by a second node in a wireless communication system is provided, the method including: receiving, from a first node, a first message carrying indication in-formation of whether the first node can enable a UE in an RRC inactive state to receive an MBS service; transmitting a second message to the first node.

According to an embodiment of the present invention, the second message carries indicating whether the second node supports the UE in the RRC inactive state to receive the MBS service.

According to yet another aspect of an embodiment of the present invention, a node device in a wireless communication network is provided, including: a transceiver; and a processor coupled with the transceiver and configured to perform the methods as described according to the embodiments.

### Advantageous Effects of Invention

The present invention provides a method and device for a multicast service transmission. The method and device for the enhanced broadcast and multicast service transmission can enable the UE to receive multicast data in the RRC inactive state, ensure the continuous reception of data, and achieve the purpose of saving power for the UE.

Advantages, and salient features of the invention will become apparent to those skilled in the art from the following detailed description, which, taken in conjunction with the annexed drawings, discloses exemplary embodiments of the invention. For more enhanced communication system, there is a need for method and apparatus for supporting a multicast service transmission.

### BRIEF DESCRIPTION OF DRAWINGS

FIG. 1 is a system architecture diagram of system architecture evolution (SAE);

FIG. 2 is a schematic diagram of an initial overall architecture of 5G;

FIG. 3 is an example of a first embodiment in which a multicast service transmission is supported according to an embodiment of the present invention;

FIG. 4 is an example of a second embodiment in which a multicast service transmission is supported according to an embodiment of the present invention;

FIG. 5 is an example of a third embodiment in which a multicast service transmission is supported according to an embodiment of the present invention;

FIG. 6 is an example of a fourth embodiment in which a multicast service transmission is supported according to an embodiment of the present invention;

FIG. 7 is an example of a fifth embodiment in which a multicast service transmission is supported according to an embodiment of the present invention;

FIG. 8 is an example of a sixth embodiment in which a multicast service transmission is supported according to an embodiment of the present invention;

FIG. 9 is an example of a seventh embodiment in which a multicast service transmission is supported according to an embodiment of the present invention;

FIG. 10 is a block diagram of a network node device according to an embodiment of the present invention;

FIG. 11 is a structure of a user equipment (UE) to which embodiments of the disclosure can be applied; and

FIG. 12 is a structure of a base station in a wireless communication system to which embodiments of the disclosure can be applied.

### MODE FOR THE INVENTION

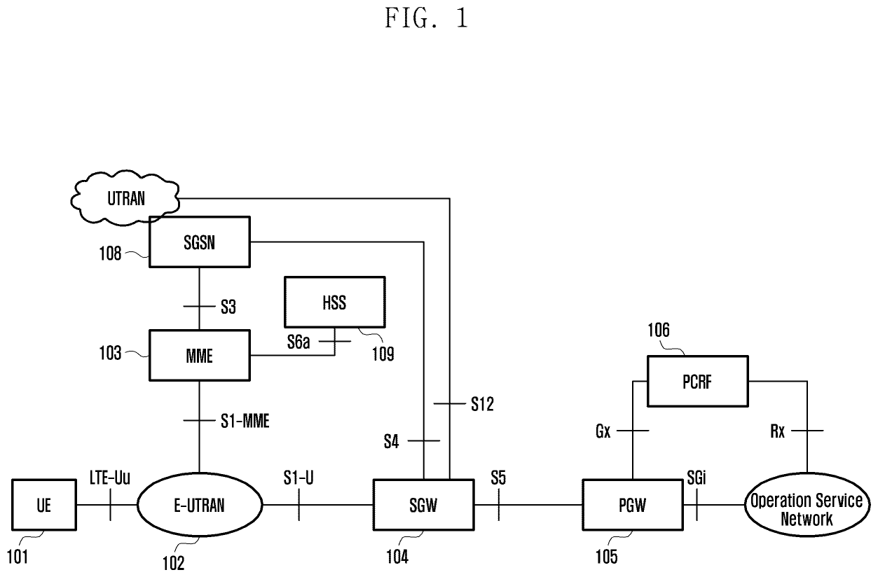

FIGS. 1 to 12 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/ or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies. In addition, the technical schemes of the embodiments of the present application can be applied to future-oriented communication technologies.

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

According to an aspect of an embodiment of the present invention, a method performed by a second node in a wireless communication system is provided, the method including: receiving, from a first node, a first message carrying related in-formation of a UE in an RRC inactive state; and processing based on the first message.

According to an embodiment of the present invention, the related information of the UE in the RRC inactive state includes one of: an identifier of the UE; a number of UEs; indication information that there is the UE in the RRC inactive state; a session identifier of an MBS that the UE joins; state information of the MBS; configuration in-formation of an MBS radio bearer (MRB); an area range; indication information of whether to support the UE in the RRC inactive state to receive an MBS service; indication information that MBS context information and/or configuration information continues to be maintained.

According to an embodiment of the present invention, the area range is a RAN paging range or a predetermined list of cells.

According to an embodiment of the present invention, the second node belongs to a same area range as the first node.

According to an embodiment of the present invention, the indication information that there is the UE in the RRC inactive state indicates that there is the UE in the RRC inactive state in a range of the first node or in an area range to which the first node belongs.

According to an embodiment of the present invention, the first message is a UE-specific message.

According to an embodiment of the present invention, the first message is one of:
a message dedicated to MBS multicast; a common message.

According to an embodiment of the present invention, the processing includes at least one of: maintaining, by the second node, UE context information; maintaining, by the second node, MBS context information; continuing, by the second node, a multicast data transmission; not releasing, by the second node, a signaling resource and/or a user plane resource of a multicast service; not initiating a multicast context release request message or not distributing a release command message to the first node by the second node.

According to an embodiment of the present invention, a number of the UE in the RRC inactive state is at least 1.

According to an embodiment of the present invention, the UE in the RRC inactive state is at the first node or an area range to which the first node belongs.

According to an embodiment of the present invention, if the second node is a base station, the processing further includes at least one of: transmitting, to a core network, a request to establish a user plane; transmitting, to a third node, a third message carrying the related information of the UE in the RRC inactive state; transmitting, to the first node, a second message carrying the related information of the UE in the RRC inactive state.

According to an embodiment of the present invention, the third message includes the related information of the UE in the RRC inactive state of the second node and/or related information of the UE in the RRC inactive state of other received nodes.

According to an embodiment of the present invention, a number of the other received nodes is at least 1.

According to an embodiment of the present invention, the second node receives, from the third node, a response message carrying the related information of the UE in the RRC inactive state of the third node.

According to an embodiment of the present invention, MRB configuration in-formation carried in the response message is the same as that carried in the third message.

According to an embodiment of the present invention, the second node is a base station, a distributed unit (DU) or a central unit (CU), and the first node is a base station or a central unit (CU).

According to another aspect of an embodiment of the present invention, a method performed by a second node in a wireless communication system is provided, the method including: receiving, from a first node, a first message carrying indication in-formation of whether the first node can enable a UE in an RRC inactive state to receive an MBS service; transmitting a second message to the first node.

According to an embodiment of the present invention, the second message carries indicating whether the second node supports the UE in the RRC inactive state to receive the MBS service.

According to yet another aspect of an embodiment of the present invention, a node device in a wireless communication network is provided, including: a transceiver; and a processor coupled with the transceiver and configured to perform the methods as described according to the embodiments.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transmission in a universal mobile telecommunications system (UMTS). A home subscriber server (HSS)109 is a home subsystem of the UE, and is responsible for protecting user information including a current location of the user equipment, an address of a serving node, user security information, and packet data context of the user equipment, etc.

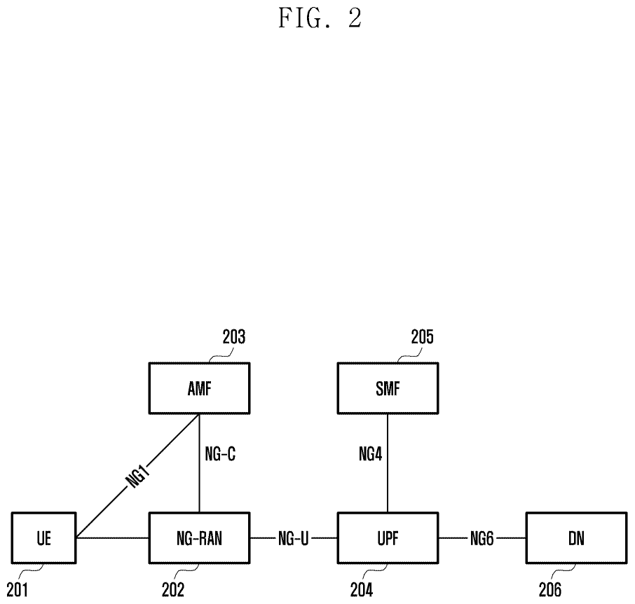

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties. An interface between the AMF and the NG-RAN is called an NG-C interface, or an NG interface or an N2 interface. An interface between the UPF and the NG-RAN is called an NG-U interface, or an N3 interface, and signaling between the UE and the AMF is called Non-Access Stratum (NAS) signaling, also called an N1 interface. An interface between base stations is called an Xn interface.

In order to make effective use of air interface resources, for services with multiple receiving users receiving the same data, the broadcast and multicast are adopted to provide service data to users. This service is called a multimedia broadcast and multicast service, hereinafter referred to as an MBS (Multicast and Broadcast Service).

There are two kinds of MBS services, one is a multicast service, in which a UE needs to join the multicast service first, and then when the multicast service starts, if the UE is in a PMM idle mode, a network transmits a paging message to let the UE enter a PMM connected mode to receive the service. One is a broadcast service, in which the UE does not need to join a certain group, and start information and configuration in-formation of the service will be transmitted to the UE by broadcast, and data can be received in all PMM connected modes and PMM idle modes.

When the MBS is a broadcast service, the base station transmits the data to the UE by broadcast, and the UE in RRC idle and connected modes can receive the data of the MBS service. When the base station is a separated architecture, information related to MBS is provided by a CU-CP to a Distributed Unit (DU), which generates MBS control messages, and MBS broadcast configuration messages, which are transmitted to the UE through common channels, for example, through MCCH. For the multicast service, the CU-CP transmits the related configuration information of the MBS to the UE through an RRC message, and only the UE in the RRC connected mode can receive the data of the MBS service.

The power of the UE is limited. In order to save power for the UE, if the UE has no other services, it is not necessary to let the UE be in the radio resource control (RRC) connected mode to receive data, and the UE can enter the RRC inactive state to receive the data of multicast services through discontinuous reception (DRX).

Nodes involved in the invention are:
a first node, a second node and a third node, including, but not limited to, at least one of: a source base station, a destination base station, a core network node, a base station Central Unit (CU) (gNB Central Unit, referred to as CU), a base station distributed unit (DU) (gNB distributed Unit, referred to as DU) or a base station central unit user plane (gNB CU-UP, referred to as CU-UP).

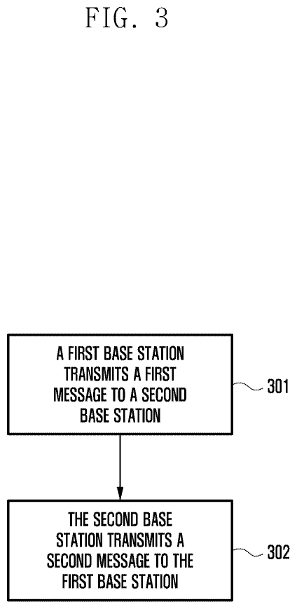

FIG. 3 describes a first embodiment in which a multicast service transmission is supported. A first node, such as a first base station, saves a context of a UE, which is aimed at one UE. The context of the UE includes an identifier of the UE, capability in-formation of the UE, information of a radio bearer of the UE, and also includes in-formation of a multicast service that the UE joins, such as a multicast session identifier (TMGI) that the UE joins. After the first base station knows the multicast service that the UE joins, if the UE is the first UE to join this service, the first base station initiates a process of establishing a user plane with a core network, that is, transmits a distribution establishment request message to the core network, and the core network transmits a distribution establishment response message to the first base station. In the process of establishing the user plane, the first base station further obtains more in-formation of the multicast service from the core network, such as a serving range of the multicast service, an identification of a QoS flow and quality requirement (QoS) parameters included in the multicast service, and multicast service state information. The multicast service state information indicates whether a service indicated by the TMGI is active or inactive. The first base station saves the information of the multicast service, that is, the context information of the MBS, which is aimed at one MBS service.

At step 301, the first base station transmits a first message to a second node, such as a second base station.

The first base station decides that the UE enters an RRC inactive state. The first base station can decide that some UEs enter the RRC inactive state to receive the MBS service according to the UE's capability, whether the UE has other unicast services to receive, a cell load, and a service state of the MBS and so on.

The first base station decides an area range, which is a predetermined area configured by an Operation Administration and Maintenance, or a specific area decided by the first base station. For example, the area range is a radio access network (RAN) paging range of the UE, which may include a list of identifiers of a group of cells, or a group of RAN area identifiers. In the invention, in this area range, if the UE in the RRC inactive state wants to receive MBS services, all base stations in this area range should maintain the data transmission of the MBS. Even if there are no users in an RRC connected mode and UEs in the RRC inactive state on a certain base station, the base station continues to save the context of the MBS, and continues the transmission of MBS data without releasing the resources of the MBS because other base stations in this area range have UEs in the RRC inactive state. To this end, the first base station transmits a message to the second base station in the area range.

In an implementation, the message may be a UE-specific message, such as an inactive UE context establishment request, an inactive UE context modification request, or other names. The message includes an identifier of XnAP allocated by the first base station for the UE, and the message may also include indication information that the UE enters the RRC inactive state. A session identifier of the MBS that the UE joins, state information of the MBS, and configuration information of an MBS radio bearer (MRB) may also be included. The configuration information of the MBS radio bearer includes at least an MRB identifier, and may also include information of a QoS flow, QoS information, a PDCP sequence number (SN) length and so on.

In an embodiment, the second node belongs to the same area range as the first node.

In another implementation, the message transmitted by the first base station to the second base station may also be a message dedicated to MBS multicast, such as a multicast activation request message, a multicast context establishment request message, a multicast context modification request message, a multicast bearer establishment request message, or other names. The message includes the identifier of XnAP allocated by the first base station for the MBS. The message transmitted by the first base station to the second base station may also be a common message, in which case the first message also includes a node identifier of the first base station. The message transmitted by the first base station is used to inform the second base station that there are UEs in the RRC inactive state to receive MBS services in an area range. In order to reduce a number of messages transmitted, the first base station may also transmit the message to the second base stations in the area range when the MBS is in an active state. The first base station may know that the MBS is in the active state from the service state of the MBS received by the core network, or when the first base station receives an MBS activation request message transmitted by the core network. The message transmitted by the first base station to the second base station carries related information of the UE in the RRC inactive state, specifically, the message includes one or more of:
an identifier of the UE. The identifier of the UE receiving MBS data in the RRC inactive state, such as C-RNTI, or RAN UE paging identifier I-RNTI, or an identifier allocated by a first base station for the UE. Here, the identifier of the UE may also be a list of UE identifiers, indicating identifiers of multiple UEs receiving MBS data in the RRC inactive state.
a number of UEs. The number of UEs receiving MBS data in the RRC inactive state, for example, the number of UEs in the RRC inactive state is at least 1.
indication information indicating that there is a UE in the RRC inactive state in the area range, for example, there is a UE in the RRC inactive state in the range of the first node or the area range to which the first node belongs.
an MBS session identifier. For example, TMGI indicates a multicast session identifier received by the UE in the inactive state.
a service state of the MBS. The service state indicates whether the multicast service is in an active state or inactive state.
an identifier of the MBS radio bearer (MRB), an identifier used to identify a radio bearer that transmits MBS data over the air interface. This is an identifier of a radio bearer allocated by the first base station to transmit the MBS service.
configuration information of the MBS radio bearer. The configuration information of the MBS radio bearer includes at least an MRB identifier, and may also include in-formation of a QoS flow, QoS information, RLC information, a PDCP SN length on the MRB and so on.
an area range. The area range may be a RAN paging range, or a list of identifiers of a group of cells, or an identification of a predetermined range. The area range indicates that there is a UE in the RRC inactive state receiving MBS services in this area.
an MBS serving range indicating a serving range of the MBS, which is a group of cell identifiers or a group of routing area identifiers.
indication information of whether to support the UE in the RRC inactive state to receive MBS services. It indicates whether a node transmitting the message has a function of allowing the UE to enter the RRC inactive mode to receive MBS services.
indication information that MBS context information and/or configuration in-formation continues to be maintained.

The second base station receives the message and saves the information in the context of the UE or the context of the MBS. At present, the UE served by the second base station has no UE to receive the multicast service, but since there are UEs to receive the multicast service in the area range, if the second base station has not established a user plane for transmitting the MBS service with the core network, the second base station transmits a distribution establishment request message to the core network to establish the user plane of the MBS service between the base station and the core network.

The second base station saves the related information of the UE in the RRC inactive state, such as the identifier of the UE or the number of the UEs in the RRC inactive state. The second base station knows that there is a UE in the RRC inactive state to receive the MBS service in the area range, and the second base station does not delete the user plane for receiving the MBS service between the base station and the core network, and continues to transmit the data of the MBS service on the radio bearer of the MBS. Even if there is no UE on the second base station to receive the MBS service, since it is known that there is a UE in the RRC inactive state on the first base station to receive the MBS service, the UE in the RRC inactive state may move to the second base station without notifying the second base station, and the second base station saves the received context of the UE in the inactive state, maintain the MBS context information, and continue the multicast data transmission, and cannot release the signaling connection of the MBS and the resources of the user plane.

The second base station may refer to the configuration information of the MRB transmitted by the first base station, and the second base station may configure the same MRB to transmit the data of the multicast service. The second base station also broadcasts the configuration information of the MRB for receiving the MBS which is configured for the UE in the inactive RRC state over the air interface.

At step 302, the second base station transmits a second message to the first base station.

The second base station transmits the second message to the first base station, which may be a response message of the first message. The message may include the in-formation of the UE in the RRC inactive state saved on the second base station.

If the first message in step 301 is aimed at one UE, the second message is also aimed at one UE. The second message includes the identifier of XnAP allocated by the second base station for the UE, and the identifier of XnAP allocated by the first base station for the UE. It also includes the session identifier of the MBS that the UE joins, and the configuration information of the MBS radio bearer (MRB) configured by the second base station for the session. The configuration information is aimed at a certain cell on the second base station, so the second message also includes the identifier of the cell. The configuration information of the MBS radio bearer includes at least the MRB identifier, and may also include the information of the QoS flow, the QoS in-formation, the PDCP sequence number (SN) length and so on. The first base station receives the configuration information of the MBS radio bearer configured by the second base station, and the first base station may include the radio bearer configuration information of the MBS configured by the second base station or a cell on the second base station in broadcast information. That is, the broadcast information of the first base station includes the MBS session identifier, or indication information identifying a certain session, cell identifier of a neighboring cell, and MRB configuration information in the cell. Alternatively, the first base station transmits an RRC reconfiguration request message to the UE, which includes the cell identifier of the neighboring cell and the MRB configuration information for a certain MBS session on the cell. The UE receives the configuration information of the neighboring cell. When the UE is in the RRC inactive state and moves to the cell, the UE may continue to receive the MBS data without entering the RRC connected state.

If the message in step 301 is a message aimed at MBS, the response message includes the identifier of XnAP allocated by the second base station for MBS and the identifier of XnAP allocated by the first base station for MBS. If the message in step 301 is a common message, the second message also includes the node identifier of the second base station. In addition, the second message may include one or more of:
an identifier of the UE. The identifier of the UE receiving MBS data in the RRC inactive state, such as C-RNTI, or RAN UE paging identifier I-RNTI, or an identifier allocated by a first base station for the UE.
a number of UEs. The number of UEs receiving MBS data in the RRC inactive state, for example, the number of UEs in the RRC inactive state is at least 1. Here, the identifier of the UE may also be a list of UE identifiers, indicating identifiers of multiple UEs receiving MBS data in the RRC inactive state. Here, the identifier of the UE may also be a list of UE identifiers, indicating identifiers of multiple UEs receiving MBS data in the RRC inactive state.
indication information indicating that there is a UE in the RRC inactive state in the area range, for example, there is a UE in the RRC inactive state in the range of the first node or the area range to which the first node belongs.
an MBS session identifier. For example, TMGI indicates a multicast session identifier received by the UE in the inactive state.
a service state of the MBS. The service state indicates whether the multicast service is in an active state or inactive state.
an identifier of the MBS radio bearer (MRB), an identifier used to identify a radio bearer that transmits MBS data over the air interface.
configuration information of the MBS radio bearer. The configuration information of the MBS radio bearer includes at least an MRB identifier, and may also include in-formation of a QoS flow, QoS information, RLC information, a PDCP SN length on the MRB and so on.
an area range. The area range may be a RAN paging range, or a list of identifiers of a group of cells, or an identification of a predetermined range. The area range indicates that there is a UE in the RRC inactive state receiving MBS services in this area.
an MBS serving range indicating a serving range of the MBS, which is a group of cell identifiers or a group of routing area identifiers.
indication information of whether to support the UE in the RRC inactive state to receive MBS services. It indicates whether a node transmitting the message has a function of allowing the UE to enter the RRC inactive mode to receive MBS services.
indication information that MBS context information and/or configuration in-formation continues to be maintained.

The first base station obtains the information of the UE in the RRC inactive state on the second base station, and saves the information in the context of the MBS.

The first base station may refer to the configuration information of the MRB transmitted by the second base station, and the first base station may configure the same MRB to transmit the data of the multicast service. The first base station also broadcasts the configuration information of the MRB for receiving the MBS which is configured for the UE in the inactive RRC state over the air interface.

When there is no UE to receive MBS services on the first base station, and the UE includes the RRC connected state and the RRC inactive state, and there is no UE to receive MBS services on all the second base stations in the area range, the first base station may delete the user plane with the core network, delete the resources of the MBS radio bearer on the base station, and stop broadcasting the configuration in-formation of the MBS radio bearer over the air interface.

Through the method of the embodiment, it can be ensured that the first base station and the second base station prepare MBS resources in advance for the UE in the RRC inactive state to receive multicast data or keep the MBS resources from being deleted, so that the UE normally receives MBS multicast data in the inactive state, and the purpose of saving power for the UE is achieved.

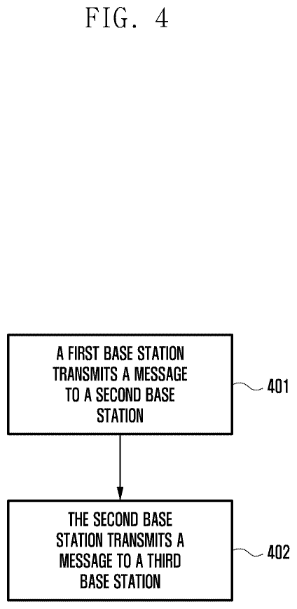

FIG. 4 describes a second embodiment in which a multicast service transmission is supported. A first node, such as a first base station, saves a context of a UE, and the context of the UE saves information of a multicast service that the UE joins, for example, an identifier TMGI of the multicast service that the UE joins has been saved in the context of the UE. In addition, after the first base station knows the multicast service that the UE joins, if the UE is the first UE to join this service, the first base station initiates a process of establishing a user plane with a core network, that is, transmits a distribution establishment request message to the core network, and the core network transmits a distribution establishment response message to the first base station. In the process of establishing the user plane, the first base station further obtains more information of the multicast service from the core network, such as a serving range of the multicast service, an identification of a QoS flow and quality requirement (QoS) parameters included in the multicast service, and multicast service state information. The multicast service state information indicates whether a service indicated by the TMGI is active or inactive. The first base station saves the information of the multicast service, that is, the context information of the MBS.

At step 401, the first base station transmits a message to a second node, such as a second base station.

The first base station decides that the UE enters an RRC inactive state. The first base station can decide that some UEs enter the RRC inactive state to receive the MBS service according to the UE's capability, whether the UE has other unicast services to receive, a cell load, and a service state of the MBS and so on.

The first base station is configured with an area range, such as a RAN paging range of a UE, which may include a list of identifiers of a group of cells, or a group of RAN area identifiers, and a central base station is also configured in this area range. In this embodiment, the second base station is a central base station. The first base station transmits a message to the second base station.

In an implementation, the message may be a UE-specific message, such as an inactive UE context establishment request, an inactive UE context modification request, or other names. The message includes an identifier of F1AP allocated by the first base station for the UE, and the message may also include indication information that the UE enters the RRC inactive state. A session identifier of the MBS that the UE joins, state information of the MBS, and configuration information of an MBS radio bearer (MRB) may also be included. The configuration information of the MBS radio bearer includes at least an MRB identifier, and may also include information of a QoS flow, QoS information, a PDCP sequence number (SN) length and so on.

In another implementation, the message transmitted by the first base station to the second base station may also be a message dedicated to the MBS multicast service, such as a multicast context establishment request message or a multicast context modification request message or other names. The message includes an identifier of XnAP allocated by the first base station for MBS. The message transmitted by the first base station to the second base station may also be a common message. The message transmitted by the first base station is used to inform the second base station that there is a UE in the RRC inactive state to receive MBS services in the area range. In order to reduce a number of messages transmitted, the first base station may also transmit the message to the second base stations in the area range when the MBS is in an active state. The first base station may know that the MBS is in the active state from the above service state of the MBS, or when the first base station receives an MBS activation request message transmitted by the core network. The message transmitted by the first base station to the second base station carries related information of the UE in the RRC inactive state, specifically, it includes one or more of:
an identifier of the UE. The identifier of the UE receiving MBS data in the RRC inactive state, such as C-RNTI, or RAN UE paging identifier I-RNTI, or an identifier allocated by a first base station for the UE. Here, the identifier of the UE may also be a list of UE identifiers, indicating identifiers of multiple UEs receiving MBS data in the RRC inactive state.
a number of UEs. The number of UEs receiving MBS data in the RRC inactive state, for example, the number of UEs in the RRC inactive state is at least 1.
indication information indicating that there is a UE in the RRC inactive state in the area range, for example, there is a UE in the RRC inactive state in the range of the first node or the area range to which the first node belongs.
an MBS session identifier. For example, TMGI indicates a multicast session identifier received by the UE in the inactive state.
a service state of the MBS. The service state indicates whether the multicast service is in an active state or inactive state.
an identifier of the MBS radio bearer (MRB), an identifier used to identify a radio bearer that transmits MBS data over the air interface.
configuration information of the MBS radio bearer. The configuration information of the MBS radio bearer includes at least an MRB identifier, and may also include in-formation of a QoS flow, QoS information, RLC information, a PDCP SN length on the MRB and so on.
an area range. The area range may be a RAN paging range, or a list of identifiers of a group of cells, or an identification of a predetermined range.
an MBS serving range indicating a serving range of the MBS, which is a group of cell identifiers or a group of routing area identifiers.
indication information of whether to support the UE in the RRC inactive state to receive MBS services. It indicates whether a node transmitting the message has a function of allowing the UE to enter the RRC inactive mode to receive MBS services.
indication information that MBS context information and/or configuration in-formation continues to be maintained.

At step 402, the second base station transmits a message to a third node, such as a third base station.

The second base station receives the message and saves the information in the context of the UE or the context of the MBS. The second base station informs other base stations in the area of the information of the UE in the RRC inactive state. After receiving the message of the first base station, the second base station may transmit the message in step 402 to other base stations in a predetermined area. Alternatively, the second base station receives the activation request message transmitted by the core network, and transmits the message in step 402 to other base stations in the predetermined area. The message may include related information of all UEs in the RRC inactive state in a specific area obtained by the second base station. Specifically, the message may include one or more of:
an identifier of the UE. The identifier of the UE receiving MBS data in the RRC inactive state, such as C-RNTI, or RAN UE paging identifier I-RNTI, or an identifier allocated by a first base station for the UE. Here, the identifier of the UE may also be a list of UE identifiers, indicating identifiers of multiple UEs receiving MBS data in the RRC inactive state.
a number of UEs. The number of UEs receiving MBS data in the RRC inactive state, for example, the number of UEs in the RRC inactive state is at least 1.
indication information indicating that there is a UE in the RRC inactive state receiving the multicast service indicated by the MBS session identifier in an area range (for example, in the range of the first node or in the area range to which the first node belongs).
an MBS session identifier. For example, TMGI indicates a multicast session identifier received by the UE in the inactive state.
a service state of the MBS. The service state indicates whether the multicast service is in an active state or inactive state.
an identifier of the MBS radio bearer (MRB), an identifier used to identify a radio bearer that transmits MBS data over the air interface.
configuration information of the MBS radio bearer. The configuration information of the MBS radio bearer includes at least an MRB identifier, and may also include in-formation of a QoS flow, QoS information, RLC information, a PDCP SN length on the MRB and so on.
an area range. The area range may be a RAN paging range, or a list of identifiers of a group of cells, or an identification of a predetermined range.
an MBS serving range indicating a serving range of the MBS, which is a group of cell identifiers or a group of routing area identifiers.
indication information of whether to support the UE in the RRC inactive state to receive MBS services. It indicates whether a node transmitting the message has a function of allowing the UE to enter the RRC inactive mode to receive MBS services.
indication information that MBS context information and/or configuration in-formation continues to be maintained.

The third base station receives the message and saves the information in the context of the UE or in the context of the MBS. If the third base station has not established the user plane of MBS with the core network, the third base station transmits a distribution establishment request message to the core network to establish the user plane of the MBS service between the base station and the core network.

The third base station saves the received information of the inactive UE, such as the identifier of the UE or the number of UEs in the RRC inactive state. The third base station knows that there is a UE in the RRC inactive state to receive the MBS service in the area range, and the third base station does not delete the user plane for receiving the MBS service between the base station and the core network, and continues to transmit the data of the MBS service on the radio bearer of the MBS. Even if there is no UE on the third base station to receive the MBS service, since the message transmitted by the second base station is obtained and it is known that there is a UE in the RRC inactive state to receive the MBS service in the predetermined area, the UE in the RRC inactive state may move to the third base station without notifying the third base station, and the third base station cannot release the signaling connection of the MBS and the resources of the user plane.

The third base station may refer to the configuration information of the MRB transmitted by the second base station, and the third base station may configure the same MRB to transmit the data of the multicast service.

At step 403, the third base station transmits a response message to the second base station.

In the response message, the third base station may also inform the second base station whether there is an inactive UE receiving the multicast service on the third base station and/or transmitting configuration information of the MRB of the multicast service on the third base station. That is, the information described in the message in step 402 is included.

Through the method of the embodiment, through the central base station, it can be ensured that the base stations in the same area prepare MBS resources in advance for the UE in the RRC inactive state to receive multicast data or keep the MBS resources from being deleted, so that the UE normally receives MBS multicast data in the inactive state, and the purpose of saving power for the UE is achieved.

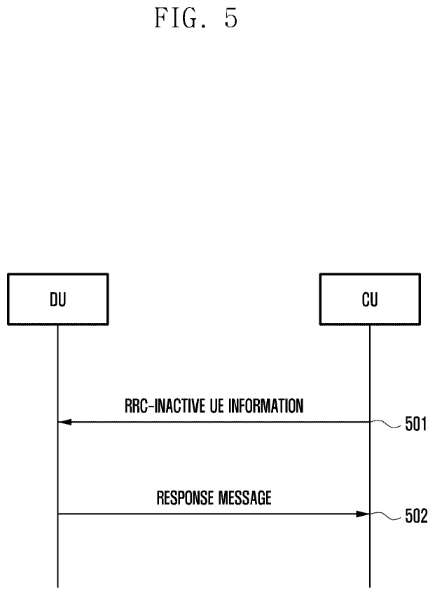

FIG. 5 describes a third embodiment in which a multicast service transmission is supported. A first node, such as a central unit CU, saves a context of a UE, and the CU belongs to a part of a separated base station. In the case of the separated base station, the base station is divided into the central unit CU and a distributed unit DU, and the CU may be further divided into a control plane (CU-CP) and a user plane (CU-UP). The following CU may also refer to the CU-CP. The CU saves the context of the UE and the context of the MBS. The context of the UE is aimed at one UE, and the context of the MBS is aimed at one MBS service. The context of the UE includes the identifier of the UE, the capability information of the UE, the information of the radio bearer of the UE, and the information of the multicast service that the UE joins, such as the multicast session identifier TMGI that the UE joins. The multicast service identifier that the UE joins is transmitted to the CU by the core network, for example, the MBS session identifier list is carried by the PDU session resource establishment request message or the PDU session resource modification request message. After knowing the multicast service that the UE joins, if the UE is the first UE to join this service, the CU initiates the process of establishing the user plane between with the core network, that is, the CU transmits a distribution establishment request message to the core network, carries the MBS session identifier and shares the transport layer address information of the NG-U. The core network transmits a distribution establishment response message to the CU, which includes more information of the multicast service, and carries the MBS session identifier, QoS flow identifier and QoS parameters included in the multicast service, and multicast service state information. The multicast service state information indicates whether the service indicated by the TMGI is active or inactive. After obtaining these information, the CU saves the information in the context in-formation of the MBS.

At step 501, the CU transmits a message to a second node, such as a DU.

The CU decides that the UE enters an RRC inactive state. The CU can decide that some UEs enter the RRC inactive state to receive the MBS service according to the UE's capability, whether the UE has other unicast services to receive, a cell load, and a service state of the MBS and so on.

The CU transmits a message to the DU, which carries the related information of the UE in the RRC inactive state.

In an implementation, the message may be a UE-specific message, such as an inactive UE context establishment request, or an inactive UE context modification request, or a UE context modification request message, or other names. The message includes the identifier of F1AP allocated by the CU for the UE, and/or the identifier of F1AP allocated by the DU for the UE, and includes the indication information that UE enters the RRC inactive state. It may also include the session identifier of the MBS that the UE joins, the state information of the MBS, and the configuration information of the MBS radio bearer (MRB). The configuration information of the MBS radio bearer at least includes an MRB identifier. After receiving the information, the DU saves the information in the context of the UE, and records that the state of the UE is the RRC inactive state.

In another implementation, the message transmitted by the CU to the DU may also be a message dedicated to the MBS multicast service, such as a multicast context establishment request message or a multicast context modification request message or other names. The message includes the identifier of F1AP allocated by the CU for MBS and/or the identifier of F1AP allocated by the DU for MBS. The message transmitted by the CU to the DU is used to inform the DU that there is a UE in the RRC inactive state to receive the MBS service in the range of the DU, or in the cell on the DU, or in the MBS multicast service area. In order to reduce a number of messages transmitted, the CU may also transmit the message to the DU when the MBS is in the active state. The CU may know that the MBS is in the active state from the service state of the MBS received by the core network, or when the CU receives an MBS activation request message transmitted by the core network. The message transmitted by the CU to the DU carries one or more of:
an MBS session identifier, such as TMGI.
area identifier information, which may be MBS service area information or identifier information of a cell.
information of RRC inactive users, which may be a number of users receiving the MBS service in the RRC inactive state, or a list of identifiers of UEs receiving the MBS service in the RRC inactive state, or indicate that there are RRC inactive users in the range indicated by the area identifier on the DU or the DU. After receiving the in-formation of RRC inactive users, the DU maintains the MBS context information, and does not initiate the multicast context release request message or multicast distribution release request message.
MBS state information. It indicates that the MBS state is the active state, which is to inform the DU that the DU needs to maintain the configuration information of MBS data and continue the transmission of the MBS data. Upon receiving the MBS state in-formation, the DU maintains the MBS context information, and does not initiate the multicast context release request message or multicast distribution release request message.
indication information that the UE in the RRC inactive state receives the MBS. The indication information indicates that the CU supports or enables or configures the UE to enter the inactive state to receive the MBS service. Upon receiving the indication in-formation, the DU maintains the MBS context information, and does not initiate the multicast context release request message or the multicast distribution release request message.
indication information that MBS context information and/or configuration in-formation continues to be maintained. Upon receiving the indication information, the DU maintains the MBS context information, and does not initiate the multicast context release request message or the multicast distribution release request message.
configuration information of the MBS radio bearer (MRB). The configuration in-formation of the MBS radio bearer includes at least an MRB identifier, and may also include information of a QoS flow, QoS information, a PDCP SN length and so on.

At step 502, the DU transmits a response message to the CU.

According to the message in step 501, the DU transmits the response message to the CU. If the message in step 501 is a message aimed at the UE, the response message includes the identifier of F1AP allocated by the CU for the UE, and the identifier of F1AP allocated by the DU for the UE.

If the message in step 501 is a message aimed at the MBS, the response message includes the identifier of F1AP allocated by the CU for MBS, and the identifier of F1AP allocated by the DU for MBS.

Through the method of the embodiment, by the message transmitted by the CU, the DU can be allowed to continue to maintain the transmission of MBS data, so that the UE normally receives MBS multicast data in the inactive state, and the purpose of saving power for the UE is achieved.

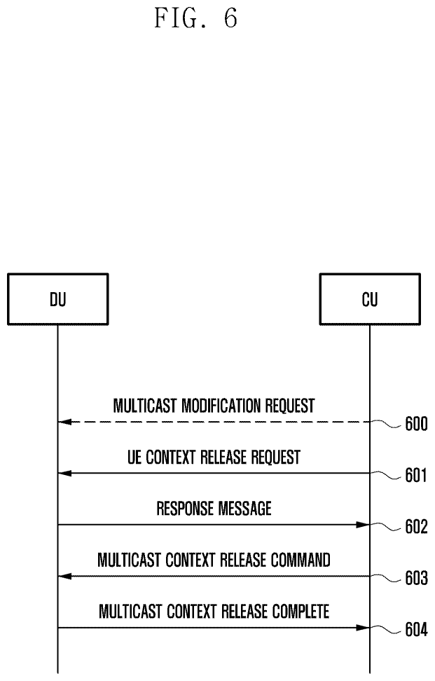

FIG. 6 describes a fourth embodiment in which a multicast service transmission is supported. A first node, for example, a central control node CU in an access network, saves a context of a UE and a context of an MBS. The context of the UE is aimed at one UE, and the context of the MBS is aimed at one MBS service. The context of the UE includes the identifier of the UE, the capability information of the UE, the in-formation of the radio bearer of the UE, and the information of the multicast service that the UE joins, such as the multicast session identifier TMGI that the UE joins. The multicast service identifier that the UE joins is transmitted to the CU by the core network, for example, the MBS session identifier list is carried by the PDU session resource establishment request message or the PDU session resource modification request message. After knowing the multicast service that the UE joins, if the UE is the first UE to join this service, the CU initiates the process of establishing the user plane between with the core network, that is, the CU transmits a distribution establishment request message to the core network, carries the MBS session identifier and shares the transport layer address information of the NG-U. The core network transmits a distribution establishment response message to the CU, which includes more information of the multicast service, and carries the MBS session identifier, QoS flow identifier and QoS parameters included in the multicast service, and multicast service state in-formation. The multicast service state information indicates whether the service indicated by the TMGI is active or inactive. After obtaining these information, the CU saves the information in the context information of the MBS.

The CU can decide to allow some UEs for MBS to enter the RRC inactive state to receive the data of the MBS service. The CU can decide that some UEs enter the RRC inactive state according to the UE's capability, whether the UE has other unicast services to receive, a cell load, and a service state of the MBS and so on. The UE enters the RRC inactive state, which means that the CU transmits an RRC release request to the UE, and the RRC release request message indicates that the UE will be in the RRC inactive state. When the UE enters the RRC inactive state, the UE can receive the broadcast message and move in the radio access network (RAN) paging range, without notifying the base station. The UE cannot transmit or receive the data of the unicast service, and the context information of the UE is only saved in the CU. In order to let the UE enter the RRC inactive state, the CU transmits a UE context release request message to the DU to release the UE information on the DU.

At step 601, the CU transmits a message to a second node, such as a DU.

The message in step 601 may be the UE context release request, which includes the identifier of F1AP allocated by CU for the UE, the identifier of F1AP allocated by DU for the UE, and the reason for release. In the present invention, the message also includes an MBS session identifier, such as TMGI, and indication information indicating that the MBS session state is the active state on the DU, or indicating that the context information of MBS needs to be maintained, or indicating the DU not to delete the context information of MBS. The context information includes information or resources of the control plane and the user plane.

If all MBS users on the DU enter the RRC inactive state, or all MBS users on a certain cell on the DU enter the RRC inactive state, the DU will release the context and resources of the MBS, thus causing the UE in the RRC inactive state to be unable to correctly receive the data of the MBS. In order to avoid this problem, the CU judges that, at the time of the last UE context release request or before transmitting the last UE context release request, the CU transmits a message to the DU, informing the DU that the MBS session state on the DU is the active state, or that the context information of the MBS needs to be maintained, or that the DU do not delete the context in-formation of the MBS.

In another implementation, before step 601, the CU may also transmit an MBS related message 600, for example, the name of the message is the multicast modification request message or others, and the message carries one or more of:
an MBS session identifier, such as TMGI.
area identifier information, which may be MBS service area information or identifier information of a cell.
information of RRC inactive users, which may be a number of users receiving the MBS service in the RRC inactive state, or a list of identifiers of UEs receiving the MBS service in the RRC inactive state, or indicate that there are RRC inactive users in the range indicated by the area identifier on the DU or the DU. After receiving the in-formation of RRC inactive users, the DU maintains the MBS context information, and does not initiate the multicast context release request message or multicast distribution release request message.
MBS state information. It indicates that the MBS state is the active state, which is to inform the DU that the DU needs to maintain the configuration information of MBS data and continue the transmission of the MBS data. Upon receiving the MBS state in-formation, the DU maintains the MBS context information, and does not initiate the multicast context release request message or multicast distribution release request message.
indication information that the UE in the RRC inactive state receives the MBS service. The indication information indicates that the CU supports or enables or configures the UE to enter the inactive state to receive the MBS service. Upon receiving the indication information, the DU maintains the MBS context information, and does not initiate the multicast context release request message or the multicast distribution release request message.
indication information that MBS context information and/or configuration in-formation continues to be maintained. Upon receiving the indication information, the DU maintains the MBS context information, and does not initiate the multicast context release request message or the multicast distribution release request message.

After receiving the message, DU maintains the multicast context information, and continues the transmission of multicast service data when there is no multicast UE context, and does not initiate the multicast context release request message to the CU or the multicast distribution release request message to the CU.

After that, the CU may transmit the message in step 601, UE context release request message, to release the context of the multicast UE saved by the DU. Even if the context of all the UEs to receive the multicast data is released, the DU continues to transmit the multicast service data until the multicast context release request message transmitted by the CU in step 803 is received.

At step 602, the DU transmits a response message to the CU.

The DU transmits a response message corresponding to the message in step 601 and confirms that the message in step 601 is received.

At step 603, the CU transmits a multicast context release command message to the DU.

When there is no UE on the CU to receive the MBS service, that is, there is no UE in the RRC connected mode to receive the MBS service, and there is no UE in the RRC inactive mode to receive the MBS service from the DU, the CU can transmit a multicast context release command message to the DU, including the reason for the release. The reason for the release may indicate that no user is to receive the MBS service. At this time, no user means that there is neither the UE in the RRC connected mode nor the UE in the RRC inactive mode to receive the MBS service. Upon receiving this message, the DU can delete the context of the MBS, delete the resources of the signaling plane and user plane related to MBS, and stop transmitting control in-formation and user data of the MBS over the air interface.

At step 604: the DU transmits a multicast context release complete message to the CU.

Upon receiving the message in step 603, the DU releases all signaling connections and user plane transmission resources related to multicast, and the DU transmits the multicast context release complete message to the CU.

Through the method of the embodiment, by the message transmitted by the CU, the DU can be allowed to continue to maintain the transmission of MBS data, so that the UE normally receives MBS multicast data in the inactive state, and the purpose of saving power for the UE is achieved.

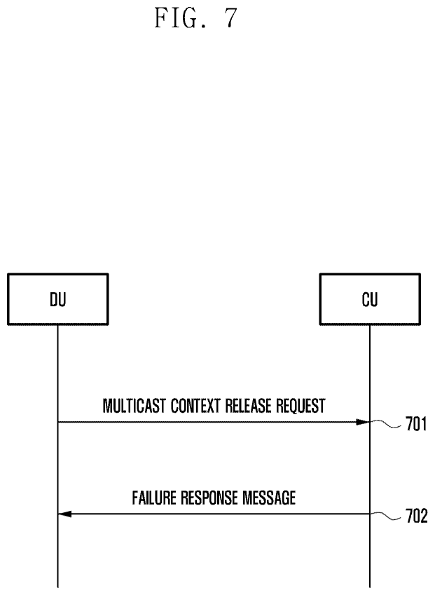

FIG. 7 describes a fifth embodiment in which a multicast service transmission is supported. In a process in which a first node, such as a DU, initiates a multicast service release request, a second node, such as a CU, indicates the DU to continue transmission of multicast service data.

701: the DU transmits a message to the CU.

Context information of a user to receive an MBS service is saved in the DU, and the identifier of the MBS radio bearer MRB is saved in the context of the UE. A bearer indicated by the MRB identifier is related to an MBS session. Through the multicast context establishment request message transmitted by the CU, the DU knows the relationship between the MBS session and the MRB, and saves this relationship in the context of the MBS. When there is no UE on the DU to receive the MBS service, that is, after the contexts of all users to receive a certain MRB are deleted, the DU may transmit a message on MBS release in step 701 to the CU, and the message in step 701 may be a multicast context release request message, a distribution release command message, or other message names.

The message on MBS release in step 701, that is, the multicast context release request message, or the distribution release command message, or other message names, includes the identifier of F1AP allocated by the CU for MBS, and the identifier of F1AP allocated by the DU for MBS, including the reason for release. The reason for the release may indicate that there is no user to receive the MBS service. Through the identifier of F1AP allocated by the CU for MBS, the CU can know which MBS service it is, and there is no user on the DU to receive the MBS service.

702: the CU transmits a failure response message to the DU.

The CU knows which MBS service it is, and there is no user to receive the MBS service on the DU. For this MBS service, the CU also saves the UE context received by the UE that is to receive the service data and is RRC inactive. Some RRC-inactive UEs need to receive MBS data from the DU, or the CU knows that there are RRC-inactive UEs to receive MBS data in a certain predetermined range, so the CU transmits a failure message as a response message to the message in step 701. The failure response message may carry indication information indicating that there are UEs in the RRC inactive mode, indicating the DU to maintain MBS context in-formation, continue transmission of multicast data, not to release signaling resources and user plane resources of the multicast service, and not to initiate the multicast context release request message or the distribution release command message to the CU.

Through the method of the embodiment, by rejecting the release request of the DU by the CU, the DU can continue to maintain the transmission of the MBS data, so that the UE normally receive the MBS multicast data in the inactive state, and the purpose of saving power for the UE is achieved.

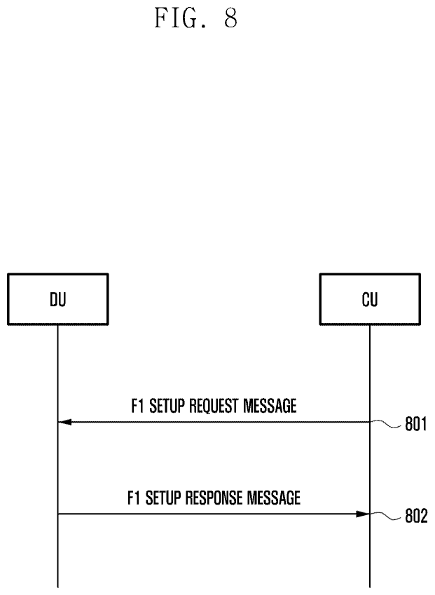

FIG. 8 describes a sixth embodiment in which a multicast service transmission is supported. In a process of establishing an F1 interface, a CU indicates a DU that the CU supports allowing a UE to enter an RRC inactive state to receive MBS data, and the DU indicates the CU that the DU supports transmission of multicast data when there is no MBS UE context.

801: a first node, such as the DU, transmits an F1 setup request message.

The DU starts the setup of the F1 interface by transmitting the F1 SETUP REQUEST message including appropriate data to a second node, such as the CU. The exchanged data are stored in their respective nodes. When the process is completed, the F1 interface may run and other F1 messages may be exchanged.

The DU should include DU system information and a slice support list in the F1 setup request message, including RAN area codes, and also information of a serving cell. The information of the serving cell includes a physical layer identifier of the cell and a unique identifier of the cell, including all MBS frequency selection area identifiers related to the cell.

The F1 setup request message also includes indication information indicating whether the DU has a function of allowing the UE to receive the MBS service in the RRC inactive state. The DU has this function, which can maintain the transmission of multicast data and the multicast context on the DU. Even when the context information of the MBS UE is not saved on the DU, the DU still transmits the multicast data without releasing signaling resources and user plane resources of the multicast service, and the DU does not initiate a multicast context release request message or a distribution release command message to the CU. The indication information may also be included in a DU configuration update request message.

802: the CU transmits an F1 setup response message.

The CU responds with the F1 setup response message including appropriate data. The F1 setup response message includes a list of cells to be activated. It also includes indication information indicating whether the CU has the function of allowing the UE to receive the MBS service in the RRC inactive state. The CU has this function, which can decide to allow the UE in the RRC connected mode to enter the RRC inactive state to receive a certain MBS multicast data. In some implementations, the CU has this function, and the CU can decide whether to release resources related to this MBS resource on the CU and DU according to whether there is a UE in the RRC inactive mode receiving MBS in a neighboring cell. The indication information may also be included in the CU configuration update request message.

Through the method of the embodiment, by acquiring whether the DU supports the function of allowing the UE to receive the MBS service in the RRC inactive state by the CU, the CU can decide to allow some UEs to enter the RRC inactive state to receive the MBS service, so as to achieve the purpose of saving power for the UE.

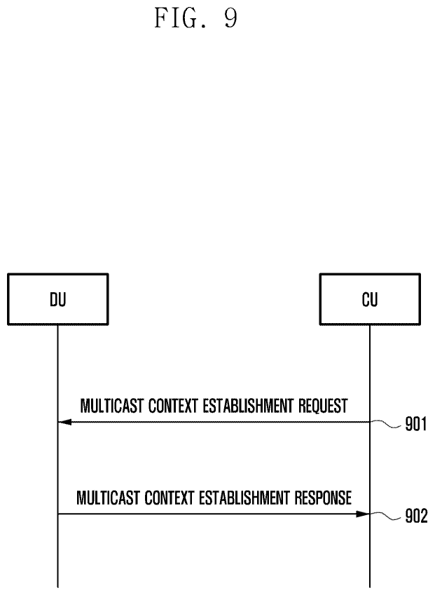

FIG. 9 describes a seventh embodiment in which a multicast service transmission is supported. In a process of establishing a multicast context, a CU indicates a DU that the CU supports allowing a UE to enter an RRC inactive state to receive MBS data, and the DU indicates the CU that the DU supports transmission of multicast data when there is no MBS UE context. The indication information may be aimed at a certain MBS multicast service or all MBS multicast services.

901: a first node, such as the CU, transmits a multicast context establishment request message to a second node, such as the DU.

The multicast context establishment request message includes the identifier of F1AP allocated by the CU for MBS, including a multicast session identifier, a multicast serving range and configuration information of a multicast radio bearer to be established. The message also includes indication information indicating that the CU supports or enables or configures the UE to enter an inactive state to receive the MBS service. Upon receiving the indication information, the DU maintains the multicast context information, and continues transmission of multicast service data when there is no multicast UE context, and does not initiate a multicast context release request message to the CU or a multicast distribution release request message to the CU.

902: the DU transmits a multicast context establishment response message to the CU.

The multicast context establishment response message includes the identifier of F1AP allocated by the DU for MBS, the identifier of F1AP allocated by the CU for MBS, and the identifier of the MBS radio bearer established successfully. The message also includes indication information indicating whether the DU has a function of allowing the UE to receive the MBS service in the RRC inactive state. The DU has this function, which can maintain the transmission of multicast data and the multicast context on the DU. Even when the context information of the MBS UE is not saved on the DU, the DU still transmits the multicast data without releasing signaling resources and user plane resources of the multicast service, and the DU does not initiate a multicast context release request message to the CU.

When knowing that the DU has this function, the CU can decide to allow some UEs to enter the RRC inactive mode to receive the MBS multicast service.

Through the method of the embodiment, by acquiring whether the DU supports the function of allowing the UE to receive the MBS service in the RRC inactive state by the CU, the CU can decide to allow some UEs to enter the RRC inactive state to receive the MBS service, so as to achieve the purpose of saving power for the UE.

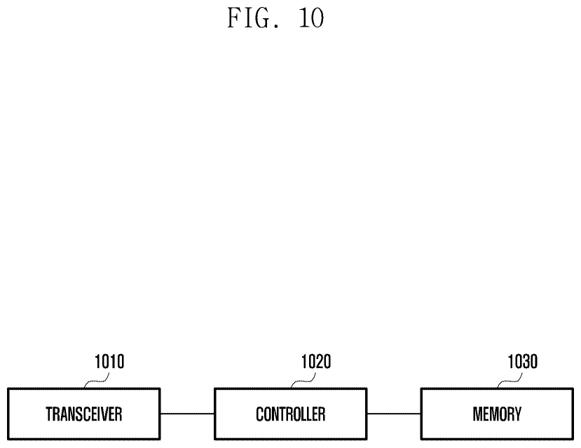

FIG. 10 is a block diagram of a node device in a network according to the present invention.

The node device in the network may be used to implement the DU, CU-UP, CU-CP, gNB, eNB source base station, destination station, source DU, source CU-UP, source CU-CP, destination DU, destination CU-UP, destination CU-CP, primary base station, secondary base station, OAM, UDM, AMF, SMF or UPF, etc. of the present invention. Referring to FIG. 10, a network device according to the present invention includes a transceiver 1010, a controller 1020 and a memory 1030. The transceiver 1010, the controller 1020 and the memory 1030 are configured to perform the operations of the methods and/or embodiments of the present invention. Although the transceiver 1010, the controller 1020 and the memory 1030 are shown as separate entities, they may be implemented as a single entity, such as a single chip. The transceiver 1010, the controller 1020 and the memory 1030 may be electrically connected or coupled to each other. The transceiver 1010 may transmit signals to and receive signals from other network devices, such as a UE, a base station or a core network node. The controller 1020 may include one or more processing units and may control the network device to perform the operations and/or functions according to one of the above embodiments.

The memory 1030 may store instructions for implementing the operations and/or functions of one of the above embodiments.

So far, the method and device for supporting the multicast service transmission according to the embodiments of the present application have been completed. By the method and device of the present application, the UE can receive the MBS data in the RRC inactive state, so as to achieve the effect of saving the energy of the UE.

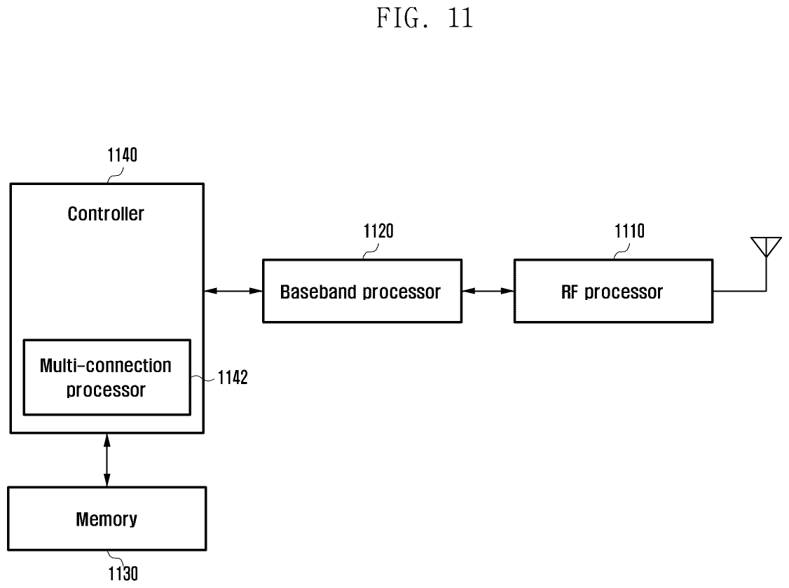

FIG. 11 is a structure of a user equipment (UE) to which embodiments of the disclosure can be applied.

The structure of the UE to which embodiments of the disclosure can be applied is illustrated in FIG. 11.

Referring to FIG. 11, the UE includes a radio frequency (RF) processor 1110, a baseband processor 1120, a storage unit 1130, and a controller 1140.

The RF processor 1110 performs a function for transmitting and receiving a signal through a wireless channel, such as band conversion and amplification of a signal. That is, the RF processor 1110 up-converts a baseband signal provided from the baseband processor 1120 into an RF band signal, transmits the RF band signal through an antenna, and then down-converts the RF band signal received through the antenna into a baseband signal. For example, the RF processor 1110 may include a transmission filter, a reception filter, an amplifier, a mixer, an oscillator, a digital-to-analog converter (DAC), an analog-to-digital converter (ADC), and the like. Although FIG. 11 illustrates only one antenna, the UE may include a plurality of antennas. In addition, the RF processor 1110 may include a plurality of RF chains. Moreover, the RF processor 1110 may perform beamforming. For the beamforming, the RF processor 1110 may control a phase and a size of each signal transmitted/received through a plurality of antennas or antenna elements. The RF processor may perform MIMO and receive a plurality of layers when performing the MIMO operation. The RF processor 1110 may appropriately configure a plurality of antennas or antenna elements according to the control of the controller to perform reception beam sweeping or control a direction of a reception beam and a beam width so that the reception beam corresponds to a transmission beam.

The baseband processor 1120 performs a function for a conversion between a baseband signal and a bitstream according to a physical layer standard of the system. For example, when data is transmitted, the baseband processor 1120 generates complex symbols by encoding and modulating a transmission bitstream. Further, when data is received, the baseband processor 1120 reconstructs a reception bitstream by demodulating and decoding a baseband signal provided from the RF processor 1110. For example, in an orthogonal frequency division multiplexing (OFDM) scheme, when data is transmitted, the baseband processor 1120 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processor 1120 divides the baseband signal provided from the RF processor 1110 in the unit of OFDM symbols, reconstructs the signals mapped to the subcarriers through a fast Fourier transform (FFT) operation, and then reconstructs a reception bitstream through demodulation and decoding.

The baseband processor 1120 and the RF processor 1110 transmit and receive signals as described above. Accordingly, the baseband processor 1120 and the RF processor 1110 may be referred to as a transmitter, a receiver, a transceiver, or a communication unit. Further, at least one of the baseband processor 1120 and the RF processor 1110 may include a plurality of communication modules to support a plurality of different radio access technologies. In addition, at least one of the baseband processor 1120 and the RF processor 1110 may include different communication modules to process signals of different frequency bands. For example, the different radio-access technologies may include an LTE network and an NR network. Further, the different frequency bands may include a super high frequency (SHF) (for example, 2.5 GHz and 5 Ghz) band and a millimeter (mm) wave (for example, 60 GHz) band.

The storage unit 1130 stores data such as basic program, an application, and setting information for the operation of the UE. The storage unit 1130 provides the stored data according to a request from the controller 1140.

The controller 1140 controls the overall operation of the UE. For example, the controller 1140 transmits/receives a signal through the baseband processor 1120 and the RF processor 1110. In addition, the controller 1140 may record data in the storage unit 1130 and read the data. To this end, the controller 1140 may include at least one processor. For example, the controller 1140 may include a communication processor (CP) that performs a control for communication, and an application processor (AP) that controls a higher layer such as an application program.

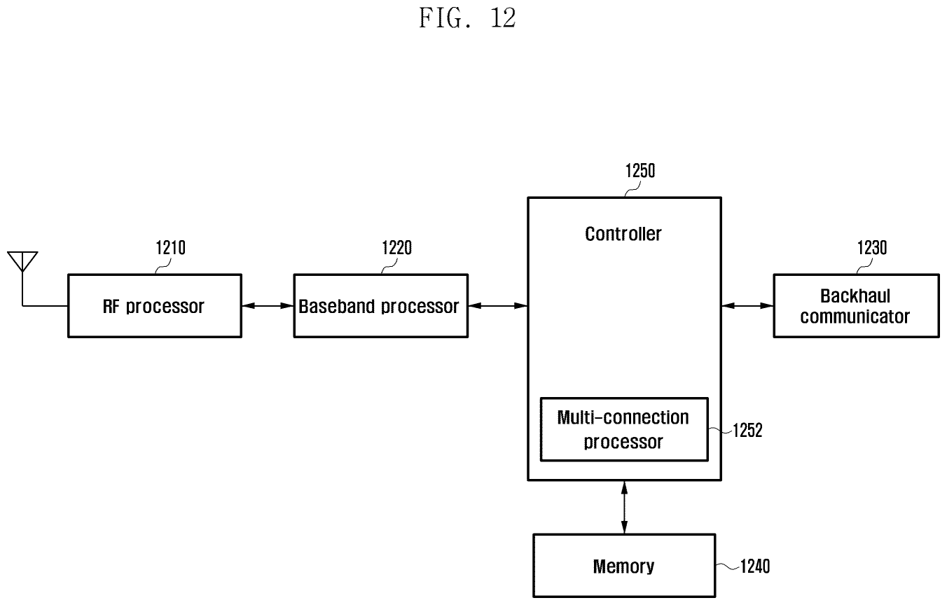

FIG. 12 is a structure of a base station in a wireless communication system to which embodiments of the disclosure can be applied.

As illustrated in FIG. 12, the base station includes an RF processor 1210, a baseband processor 1220, a backhaul communication unit 1230, a storage unit 1240, and a controller 1250.

The RF processor 1210 performs a function for transmitting and receiving a signal through a wireless channel, such as band conversion and amplification of a signal. That is, the RF processor 1210 up-converts a baseband signal provided from the baseband processing unit 1220 into an RF band signal and then transmits the converted signal through an antenna, and down-converts an RF band signal received through the antenna into a baseband signal. For example, the RF processor 1210 may include a transmission filter, a reception filter, an amplifier, a mixer, an oscillator, a DAC, and an ADC. Although FIG. 12 illustrates only one antenna, the first access node may include a plurality of antennas. In addition, the RF processor 1210 may include a plurality of RF chains. Moreover, the RF processor 1210 may perform beamforming. For the beamforming, the RF processor 1210 may control a phase and a size of each of the signals transmitted and received through a plurality of antennas or antenna elements. The RF processor may perform a downlink MIMO operation by transmitting one or more layers.

The baseband processor 1220 performs a function of performing conversion between a baseband signal and a bitstream according to a physical layer standard of the first radio access technology. For example, when data is transmitted, the baseband processor 1220 generates complex symbols by encoding and modulating a transmission bitstream. Further, when data is received, the baseband processor 1220 reconstructs a reception bitstream by demodulating and decoding a baseband signal provided from the RF processor 1210. For example, in an OFDM scheme, when data is transmitted, the baseband processor 1220 may generate complex symbols by encoding and modulating the transmission bitstream, map the complex symbols to subcarriers, and then configure OFDM symbols through an IFFT operation and CP insertion. In addition, when data is received, the baseband processor 1220 divides a baseband signal provided from the RF processor 1210 in units of OFDM symbols, recovers signals mapped with sub-carriers through an FFT operation, and then recovers a reception bitstream through demodulation and decoding. The baseband processor 1220 and the RF processor 1210 transmit and receive signals as described above. Accordingly, the baseband processor 1220 and the RF processor 2010 may be referred to as a transmitter, a receiver, a transceiver, or a communication unit.

The communication unit 1230 provides an interface for communicating with other nodes within the network.

The storage unit 1240 stores data such as a basic program, an application, and setting information for the operation of the MeNB. Particularly, the storage unit 1240 may store information on bearers allocated to the accessed UE and the measurement result reported from the accessed UE. Further, the storage unit 1240 may store information on a reference for determining whether to provide multiple connections to the UE or stop the multiple connections. In addition, the storage unit 1240 provides data stored therein according to a request from the controller 1250.

The controller 1250 controls the overall operation of the MeNB. For example, the controller 1250 transmits and receives a signal through the baseband processor 1220 and the RF processor 1210 or through the backhaul communication unit 1230. In addition, the controller 1250 may record data in the storage unit 1240 and read the data. To this end, the controller 1250 may include at least one processor.

Although the present disclosure has been described with various embodiments, various changes and modifications may be suggested to one skilled in the art. It is intended that the present disclosure encompass such changes and modifications as fall within the scope of the appended claims.

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logical blocks, modules, circuits, and steps described in this application may be implemented as hardware, software, or a combination of both. To clearly illustrate this inter-changeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described functional sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors co-operating with a DSP core, or any other such configuration.

The steps of the method or algorithm described in this application may be embodied directly in hardware, in a software module executed by a processor, or in a combination thereof. The software module may reside in RAM memory, flash memory, ROM memory, EPROM memory, EEPROM memory, register, hard disk, removable disk, or any other form of storage medium known in the art. An exemplary storage medium is coupled to a processor to enable the processor to read and write information from/to the storage media. In an alternative, the storage medium may be integrated into the processor. The processor and the storage medium may reside in an ASIC. The ASIC may reside in a user terminal. In an alternative, the processor and the storage medium may reside in the user terminal as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

1-15. (canceled)

16. A method performed by a central unit (CU) of a base station in a wireless communication system, the method comprising:
deciding whether a multicast reception in a radio resource control (RRC) inactive state is applied;
based on the decision, transmitting, to a distributed unit (DU) of the base station, a request message including information associated with the multicast reception in the RRC inactive state; and
as a response to the transmission of the request message, receiving, from the DU of the base station, a response message.

17. The method of claim 16, wherein the information associated with the multicast reception in the RRC inactive state indicates an activation of the multicast reception in the RRC inactive state in a cell.

18. The method of claim 16, wherein the request message further includes at least one of identifier (ID) information of a multicast-broadcast service (MBS) radio bearer (MRB), quality of service (QOS) information of the MRB, QoS flow information of the MRB, or packet data convergence protocol (PDCP) sequence number (SN) length information.

19. The method of claim 16, wherein the request message further includes first information on a MBS F1 application protocol (F1AP) identifier (ID) of the CU and second information on a MBS F1AP ID of the DU.

20. The method of claim 16, wherein the request message is a multicast context modification request message.

21. A method performed by a distributed unit (DU) of a base station in a wireless communication system, the method comprising:
receiving, from a central unit (CU) of the base station, a request message including information associated with the multicast reception in the RRC inactive state; and
as a response to the reception of the request message, transmitting, to the DU of the base station, a response message.

22. The method of claim 21, wherein the information associated with the multicast reception in the RRC inactive state indicates an activation of the multicast reception in the RRC inactive state in a cell.

23. The method of claim 21, wherein the request message further includes at least one of identifier (ID) information of a multicast-broadcast service (MBS) radio bearer (MRB), quality of service (QOS) information of the MRB, QoS flow information of the MRB, or packet data convergence protocol (PDCP) sequence number (SN) length information.

24. The method of claim 21, wherein the request message further includes first information on a MBS F1 application protocol (F1AP) identifier (ID) of the CU and second information on a MBS F1AP ID of the DU.

25. The method of claim 21, wherein the request message is a multicast context modification request message.

26. A central unit (CU) of a base station in a wireless communication system, the CU comprising:
a transceiver, and
a controller coupled with the transceiver, and configured to:
decide whether a multicast reception in a radio resource control (RRC) inactive state is applied,
based on the decision, transmit, to a distributed unit (DU) of the base station, a request message including information associated with the multicast reception in the RRC inactive state, and
as a response to the transmission of the request message, receive, from the DU of the base station, a response message.

27. The CU of claim 26, wherein the information associated with the multicast reception in the RRC inactive state indicates an activation of the multicast reception in the RRC inactive state in a cell.

28. The CU of claim 26, wherein the request message further includes at least one of identifier (ID) information of a multicast-broadcast service (MBS) radio bearer (MRB), quality of service (QOS) information of the MRB, QoS flow information of the MRB, or packet data convergence protocol (PDCP) sequence number (SN) length information.

29. The CU of claim 26, wherein the request message further includes first information on a MBS F1 application protocol (F1AP) identifier (ID) of the CU and second information on a MBS F1AP ID of the DU.

30. The CU of claim 26, wherein the request message is a multicast context modification request message.

31. A distributed unit (DU) of a base station in a wireless communication system, the method comprising:
a transceiver, and
a controller coupled with the transceiver, and configured to:
receive, from a central unit (CU) of the base station, a request message including information associated with the multicast reception in the RRC inactive state, and
as a response to the reception of the request message, transmit, to the DU of the base station, a response message.

32. The DU of claim 31, wherein the information associated with the multicast reception in the RRC inactive state indicates an activation of the multicast reception in the RRC inactive state in a cell.

33. The DU of claim 31, wherein the request message further includes at least one of identifier (ID) information of a multicast-broadcast service (MBS) radio bearer (MRB), quality of service (QOS) information of the MRB, QoS flow information of the MRB, or packet data convergence protocol (PDCP) sequence number (SN) length information.

34. The DU of claim 31, wherein the request message further includes first information on a MBS F1 application protocol (F1AP) identifier (ID) of the CU and second information on a MBS F1AP ID of the DU.

35. The DU of claim 31, wherein the request message is a multicast context modification request message.
